(19) United States
(12) Patent Application Publication
(10) Pub. No.: US 2022/0248598 A1
(43) Pub. Date: Aug. 11, 2022

(54) Connect-N-Grab

(71) Applicant: Ervin Besler, Grants Pass, OR (US)

(72) Inventor: Ervin Besler, Grants Pass, OR (US)

(21) Appl. No.: 17/174,110

(22) Filed: Feb. 11, 2021

(51) Int. Cl. A01D 7/10; A01D 11/06

(52) U.S. Cl. CPC A01D 7/10; A01D 11/06

(57) ABSTRACT

This invention is made to attach to two individual rake handles and, thereby, to create a pickup tool to pickup leaves or any yard debris and to facilitate the dispose of it. The invention is designed to attach two rake handles and to remain on the handles. The invention is also designed to separate at the center by rotating the rake handles all the way to release. While rotating toward the end, it will automatically separate into two individual rakes. Each rake can be used separately to collect yard debris into a pile. Only the straight bottom rakes are used on the invention. The invention can be attached to wood, metal, aluminum and fiberglass rake handles. The rakes can be mix-matched, similar, large or small, new or old. Any rake with steel, aluminum, plastic or fiberglass tines can be used. This invention is made to attach to two individual rake handles and, thereby, to create a pickup tool to pickup leaves or any yard debris and to facilitate the dispose of it. The invention is designed to attach two rake handles and to remain on the handles. The invention is also designed to separate at the center by rotating the rake handles all the way to release. While rotating toward the end, it will automatically separate into two individual rakes. Each rake can be used separately to collect yard debris into a pile. Only the straight bottom rakes are used on the Connect-N-Grab. The invention can be attached to wood, metal, aluminum and fiberglass rake handles. The rakes can be mix-matched, similar, large or small, new or old. Any rake with steel, aluminum, plastic or fiberglass tines can be used.

### BRIEF DESCRIPTION OF THE DRAWINGS

The drawings are as follows:

FIG. 1 is a Connect-N-Grab device;

FIG. 2 is a pair of rakes attached to a Connect-N-Grab device;

FIG. 3 is a Connect-N-Grab device;

FIG. 4 is a Connect-N-Grab device;

FIG. 5 is a Connect-N-Grab device;

FIG. 6 is a pair of rakes attached to a Connect-N-Grab device;

FIG. 7 is a Connect-N-Grab device;

FIG. 8 is a Connect-N-Grab device;

FIG. 9 is a Connect-N-Grab device;

FIG. 10 is a Connect-N-Grab device;

FIG. 11 is a Connect-N-Grab device;

FIG. 12 is a Connect-N-Grab device;

FIG. 13 is two pair of rakes with each pair attached to a Connect-N-Grab device;

FIG. 14 is a pair of rakes attached to a Connect-N-Grab device; and

FIG. 15 is a pair of rakes used in two ways.

### DETAILED DESCRIPTION

This invention is named Connect-N-Grab, which is made to attach to two individual rake handles and, thereby, create a pickup tool as shown on FIGS. 6, 13, 14, and 15. Coupled rakes are useful to pickup leaves or any yard debris and to facilitate the dispose of such.

The Connect-N-Grab is designed to attach two rake handles and to remain on the handles. The Connect-N-Grab is also designed to separate at the center by rotating the rake handles to release. While rotating toward the end, the rakes will separate into two individual rakes as show in FIG. 2. Each rake can be used separately to collect yard debris into a pile. Only straight bottom rakes are used on the Connect-N-Grab, as shown in FIGS. 2, 6, 13, 14, and 15.

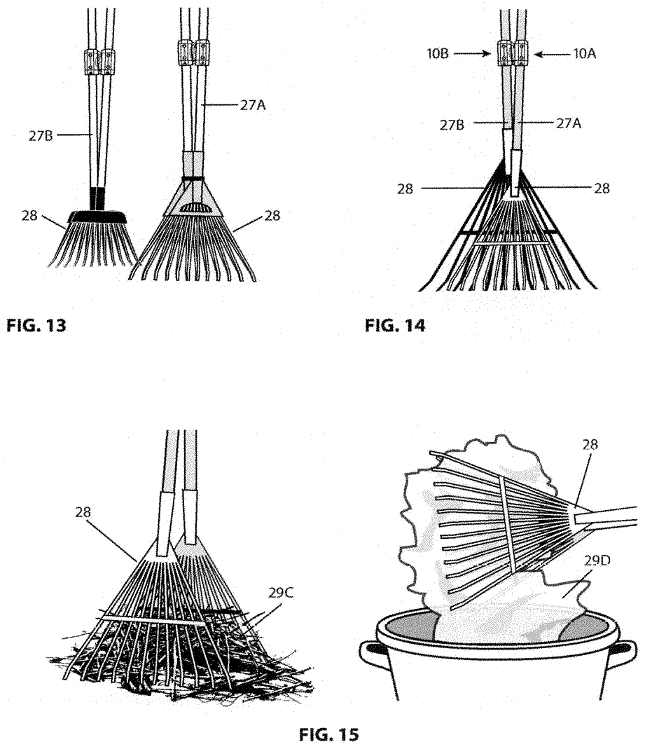

The Connect-N-Grab can be attached to wood, metal, aluminum and fiberglass rake handles as shown in FIGS. 13 and 14. The rakes can be mix-matched, similar, large or small, new or old. Any rake with steel, aluminum, plastic or fiberglass tines can be used.

The purpose of the Connect-N-Grab is to be able to connect two rakes together to form a double pickup rake combination, thus enabling the user to pickup all types of yard debris without bending over, making the removal process much faster and easier.

The separation of the two rakes can be done quickly from the pickup configuration, to individual rakes. This is accomplished by twisting the Connect-N-Grab in one direction to separate and then twisting the Connect-N-Grab in the opposite direction to reconnect. By rotating the rake handles, the Connect-N-Grab will separate the rakes see, FIGS. 10, 11, and 12.

The Connect-N-Grab separates and reconnects at a center of parts 10A and 10B of FIGS. 10, 11, and 12. The axle 16 and additional length 16A is molded into surface 20 of part 10B. Hole 17 on surface 19 of part 10A pivots or rotates on stationary axle 16 and additional length 16A. When parts 10A and 10B are connected together, they are held together by two claws 22 of part 10B hook to and slide on lip 23 of part 10A as part 10A pivots or rotates on the axle 16 and additional length 16A.

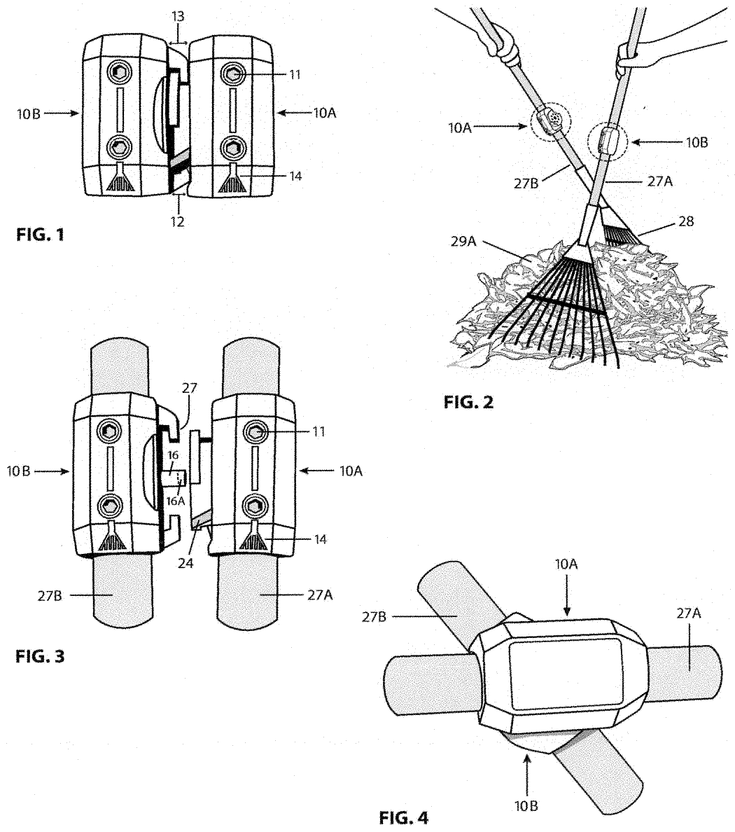

FIG. 1. Each of area 12 and area 13 plays a very important part. The distance between part 10A and part 10B on area 12 is less than area 13. This accomplishes the change in the position of the rake toward each other after it is attached on the rake handle when in the pickup position. It is designed with a proper space in the distance between 12 and 13. The distance attaching the Connect-N-Grab from the rake tine to the distance already established on the rake handle. The rake tines will then line up directly over each other when the pickup configuration is in the closed position.

As shown in FIGS. 13 and 14, different styles and sizes of rakes will use the same measurement on the rake handles. In FIGS. 1, 2, 7, 11 and 12, rake symbol 14 shows which direction to attach the Connect-N-Grab on the rake handle. The rake symbol on the Connect-N-Grab must face down toward the rake tines.

FIG. 2 shows two rakes with part 10A and part 10B separated from each other. Part 10A and part 10B remain on the rake handles permanently. It only takes five seconds to reconnect or to separate the rakes for single use or pickup use.

FIGS. 1, 3, 5, 7, 10, 11, and 12 shows cup point set screws 11 on the Connect-N-Grab. Two cup point set screws—one toward each end on part 10A and the same on part 10B.

As shown in FIGS. 7 and 8, surface area 15 plays a very important part. On each side of part 10A and part 10B there is a surface area 15 and a surface area 30, which have less than a 45-degree angle between flat portions thereof. Once the rake handle rest on surface area 15, the rake handle will be locked into place by the force of cup point set screws 11. The Connect-N-Grab is also designed to fit all different diameter of rake handles, which handles will not touch surface area 30.

FIGS. 10 and 12 show axle 16 with additional length 16A. The purpose of the extra length on axle 16 is to make it easier to reconnect part 10A to part 10B in any position, as shown on FIG. 11. By turning to the right spot axle 16 will automatically drop down into the correct position ready to be used in the pickup configuration.

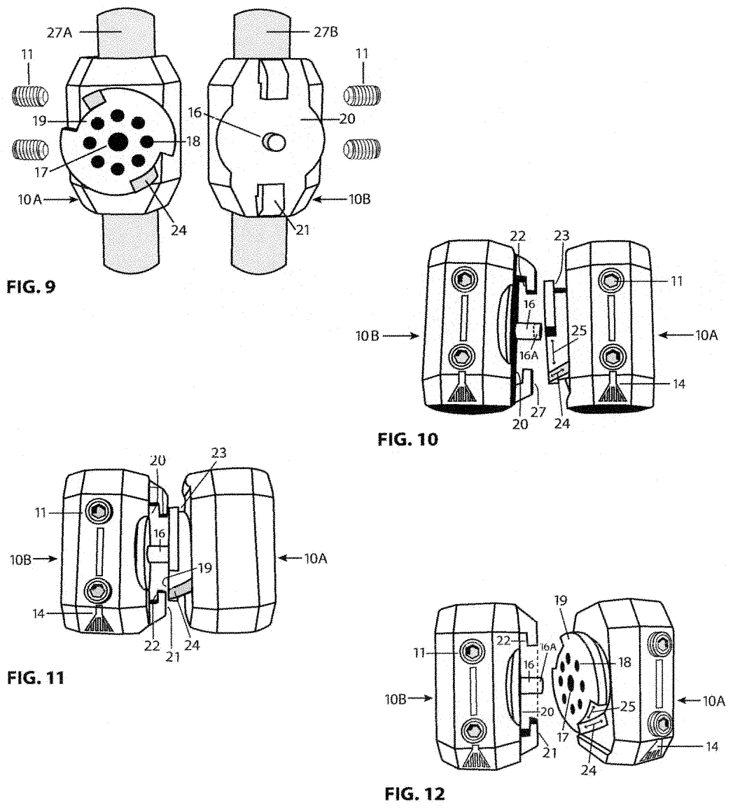

As shown in FIGS. 9 and 12, on surface 19 there are 8 holes larger than ⅛″ in diameter. The holes are there to keep this area from shrinking unevenly. Surface 19 is thicker than other molded areas and it has more material to shrink. When the Connect-N-Grab is removed from the injection mold, it is very hot, as it cools the material shrinks and warps slightly in certain areas. The eight holes alleviate the issue of warping.

FIG. 2 shows the Connect-N-Grab with part 10A and part 10B separated but still attached to the handles of each rake. The rakes are being used as a regular rake to gather yard debris into a pile.

FIG. 6 shows the Connect-N-Grab reconnected in the pickup rake set-up ready to grab yard debris or leaves.

FIG. 15 shows there are a lot more uses with the pickup rake than only to pickup leaves. Rake 28 is great for twigs 29C, garbage, plus many more uses as well.

FIG. 13 shows different sizes and shapes of the flat bottom rakes that are similar.

FIG. 14 shows mixed size flat bottom rakes.

Four simple steps are used to attach the Connect-N-Grab onto rake handle and have the proper distance to where the Connect-N-Grab attaches on the handle. This is done by measuring the distance from the outer edge of the tines to the correct location on the rake handle. This distance is established when both rake tines are directly over each other when they are put together into a pickup rake. The same distance measurement on the rake handles is for all different sizes of flat-bottom rakes.

The Connect-N-Grab has a dual purpose.
A. FIG. 6 Connect-N-Grab is connected together into a pickup rake.
B. FIG. 2 rotate the handle of the rake all the way until it reaches the end, the Connect-N-Grab will separate between part 10A and part 10B into two individual rakes.

Advantages of owning the Connect-N-Grab include:
A. It is small and lightweight.
B. Inexpensive to ship.
C. Takes very little room in the store.
D. It universally fits flat bottom rakes of all sizes giving the customer more choice when purchasing a rake.
E. The purchaser can use currently owned rakes.

FIG. 1 shows a very important aspect in this invention. This aspect is related to the distance between 12 and 13 on the Connect-N-Grab and the distance between the outer rake tines to the right distance to attach the Connect-N-Grab to the rake handle. When the proper distance is established, the two rakes tines will line up directly over each other. This is done when the Connect-N-Grab is first attached to the rake handle. The same measurement applies to all sizes of flat-bottom rakes.

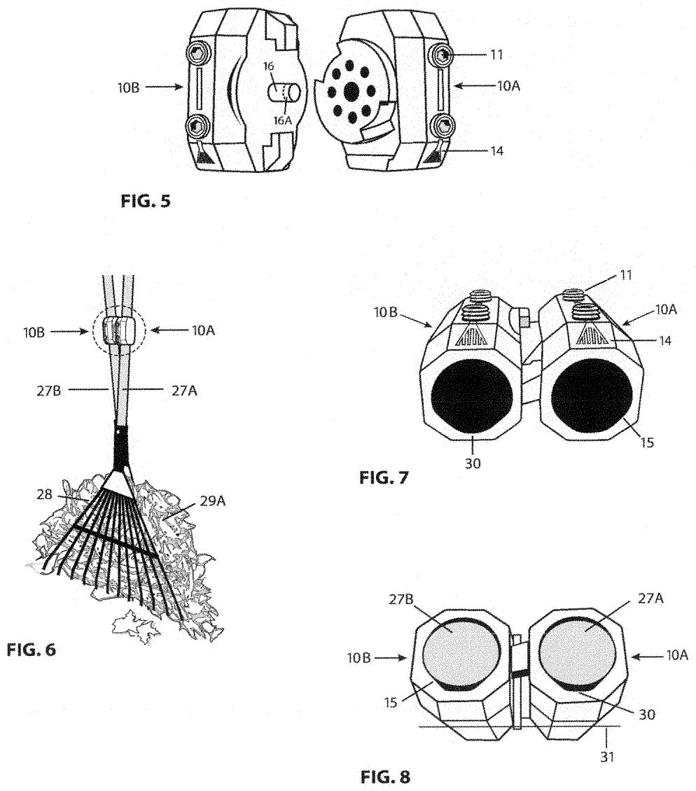

FIG. 5 shows the direction to connect and to disconnect by a simple twist, which is used to join two rakes into a pickup rake. Or twist the opposite direction to separate into two individual rakes.

FIGS. 7 and 8 show a very important part of this invention. Each of part 10A and part 10B has surface area 30 and surface area 15 with angles between adjacent flat sides that are less than 45 degrees. Rake handles 27A and 27B rest against an opposing side of part 10A and Part 10B from the side on which two cup point set screws 11 are located. When two cup point set screws 11 force the rake handle against surface area 15, two cup point set screws 11 locks the handle in between and it will keep the rake handle from moving. Having proper distance between two flat surface areas 15, any diameter of rake handle that fits into the Connect-N-Grab will not touch surface area 30.

FIG. 9 shows the cup point set screws 11 that play a very important role. This is what secures the rake handle in place inside the Connect-N-Grab of 10A and 10B, against two surface areas 15.

FIGS. 10 and 12 show the stationary axle 16 on part 10B attach to the surface 20. Axle 16 has an additional length 16A making it easier to connect part 10A and part 10B to a rake. Even if part 10B is not in the right position to drop down to connect, by turning slightly, part 10B will ride down ramp 24 to connect.

FIGS. 10 and 12 show the importance of ramp 24 to this invention. Via connecting part 10A and part 10B, individual rakes can be coupled to create a pickup rake. As one turns part 10B clockwise, outer surface claw 21 of part 10B will slide down the ramp 24. As claw 21 of part 10B sets on the bottom of ramp 24, inner claw 22 will hook and slide on inner lip 23 of part 10A, as in this position the pickup rake will be in a functional position as a pickup rake. To separate into two individual rakes again, one rotates a rake handle on the Connect-N-Grab all the way. As soon as the outer claw 21 hits the ramp 24 it will slide on the ramp to the top of the surface and separate back to two individual rakes.

FIGS. 9 and 12 show that there are eight holes 18, each of which are larger than ⅛″ in diameter. The reason for these holes is for even shrinkage of the surface 19. This area is thicker and has more material than other areas. Shrinkage occurs when hot mold material cools—without the holes, shrinking in this area results in warping. Holes 18 allow this area to remain even after cooling.

FIG. 8 is also important—on the bottom of Connect-N-Grab there is a flat surface area 31.

Tines of each rake 28 must lay flat on a surface, in line with each other, before tightening cup point set screws 11.

What is claimed is:

1-11. (canceled)

12. A system comprising:
a first rake, the first rake comprising a first handle;
a second rake, the second rake comprising a second handle; and
a Connect-N-Grab, the Connect-N-Grab comprising a plurality of set screws, the Connect-N-Grab designed to attach the first handle of the first rake to the second handle of the second rake via the plurality of set screws, the Connect-N-Grab comprising a first part and a second part, the first part having a hole and a lip, the second part having an axle and two claws, wherein the first part is releasably attachable to the second part via engagement of the axle with the hole and engagement of the two claws of the second part with the lip of the first part, the first part having a ramp, wherein the first part is aligned with the second part for coupling via both of the two claws riding down the ramp.

13. The system of claim 12, wherein:
the first part of the Connect-N-Grab has a plurality of holes, the plurality of holes keeping the first part of the Connect-N-Grab from warping after removal from an injection mold.

14. The system of claim 12, wherein:
when the first part is coupled to the second part, a distance between an upper part of the first part and the second part is greater than a distance between a lower part of the first part and the second part.

15. The system of claim 12, wherein:
when the first part is coupled to the second part via rotation of the first part relative to the second part.

16. The system of claim 12, wherein:
when the first part is uncoupled from the second part via rotation of the first part relative to the second part.

17. The system of claim 12, wherein:
coupling the first rake to the second rake via the Connect-N-Grab creates a double pickup rake combination.

18. A system comprising:
a first rake, the first rake comprising a first handle;
a second rake, the second rake comprising a second handle; and
a device, the device comprising a plurality of set screws, the device designed to attach the first handle of the first rake to the second handle of the second rake via the plurality of set screws, the device comprising a first part and a second part, the first part having a hole and a lip, the second part having an axle and two claws, wherein the first part is releasably attachable to the second part via engagement of the axle with the hole and engagement of the two claws of the second part with the lip of the first part.
